(19) United States
(12) Patent Application Publication
(10) Pub. No.: US 2008/0214209 A1
(43) Pub. Date: Sep. 4, 2008

(54) Web to Mobile Device Location Based Event Reminder

(75) Inventor: Nitesh Ratnakar, Elkins, WV (US)

Correspondence Address: NITESH RATNAKAR, ROUTE 3,, BOX 179-A, ELKINS, WV, 26241, US

(73) Assignee: Novation Science, LLC, Elkins, WV (US)

(21) Appl. No.: 12/122,705

(22) Filed: May 18, 2008

(51) Int. Cl. H04Q 7/20

(52) U.S. Cl. 455/456.1

(57) ABSTRACT

Web page ‘event information’ template is provided comprising of data fields to enable users input event information published on corresponding web page. Web page ‘event information’ data can be published or can be imbedded in corresponding web page. Mobile device ‘event information’ database is provided comprising of data fields identical to web page ‘event information’ database. Two way data transmission means between web page and mobile device ‘event information’ databases is provided. Mobile device event reminder application is provided with means to determine if GPS coordinates corresponding to current location of mobile device corresponds to GPS coordinates in ‘event information’ database contained therein. Event information is displayed if mobile device is in proximity to event location.

### BACKGROUND AND PRIOR ART

It is a common practice to look up information on the internet. Many web pages contain location specific event information. Users currently have to memorize event information published on the web. Many users print web page containing event information for future reference. Sometime users manually enter event information published on the web into mobile devices for future reference. As is evident, remembering event information published on web page can be a cumbersome and challenging task. Moreover, current methods do not remind uses of event information when users are present in proximity to event location. Hence there remains a need for an event reminder system whereby event information published on the web can easily be saved in mobile devices, especially GPS enabled mobile devices, and later automatically retrieved when user is physically present in proximity to event location.

### SUMMARY

Web page ‘event information’ template is provided comprising of data fields to enable users input event information published on corresponding web page. Web page ‘event information’ data can be published or can be imbedded in corresponding web page. Mobile device ‘event information’ database is provided comprising of data fields identical to web page ‘event information’ database. Two way data transmission means between web page and mobile device ‘event information’ databases is provided. Mobile device event reminder application is provided with means to determine if GPS coordinates corresponding to current location of mobile device corresponds to GPS coordinates in ‘event information’ database contained therein. Event information is displayed if mobile device is in proximity to event location.

### BRIEF DESCRIPTION OF DRAWINGS

FIG. 1 shows web page containing local event information; and web page ‘event information’ template containing data fields for input of local event information.

FIG. 2 shows web page ‘event information’ and mobile device ‘event information’ templates; and illustrates method of transfer of event information between web page ‘event information’ and mobile device ‘event information’ databases.

FIG. 3 illustrates a mobile device event reminder application determining current location GPS coordinates; determining if current location GPS coordinates corresponds to GPS coordinates contained in mobile device ‘event information’ database; and displaying event information corresponding to current mobile device GPS coordinates.

### DETAIL DESCRIPTION OF DRAWINGS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out one or several purposes of the present invention. It is important, therefore, that the claims be regarded as including such equivalent constructions insofar as they do not depart from the spirit and scope of the present invention.

The basic architecture of the system comprised of web page ‘event information’ database; mobile device ‘event information’ database; and mobile device ‘event reminder’ application.

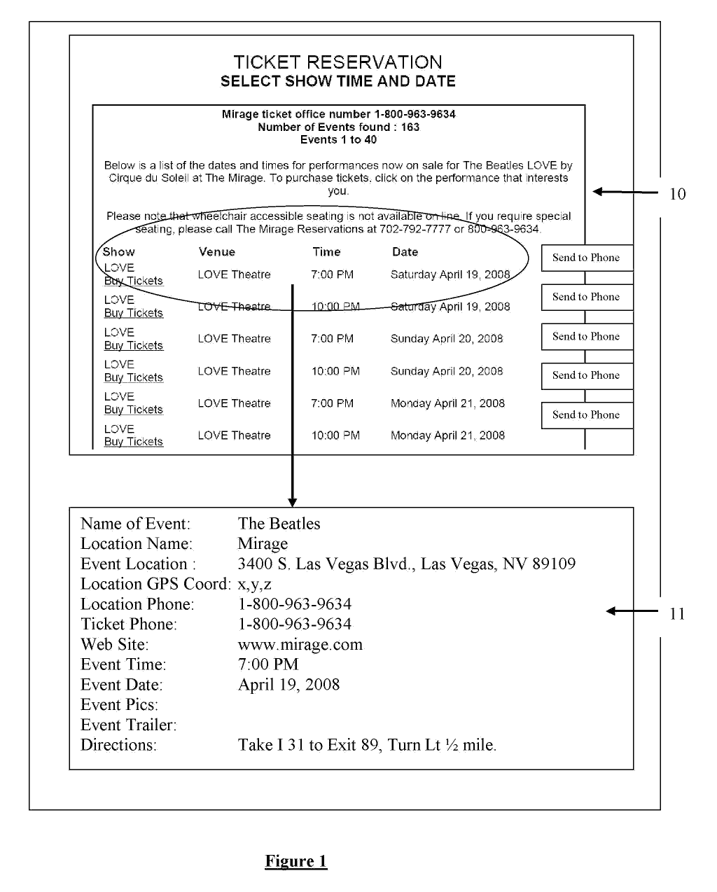

FIG. 1 shows a web page (10) containing event information and event location. It also shows a web page ‘event information’ template (11) containing data fields for input of event name, event time, event location, GPS coordinates corresponding to event location, phone, fax, web site, email, and any other pertinent information regarding corresponding event. Preferably, event information is in one or more of text, audio, video and picture formats. GPS coordinates corresponding to event location is obtained from geo code database. Event information published on web page (10) is entered into corresponding data fields of web page ‘event information’ template (11). Data contained in web page ‘event information’ database can be published on corresponding web page or embedded into corresponding web page. FIG. 1 shows an example of web page (10) displaying local event information wherein event information is also input into corresponding data fields of web page ‘event information’ template (11); and wherein web page ‘event information’ data is embedded into corresponding web page. Accordingly, when user clicks on ‘send to phone’ button on web page (10), information contained in corresponding web page ‘event information’ database (11) is transmitted to select mobile device.

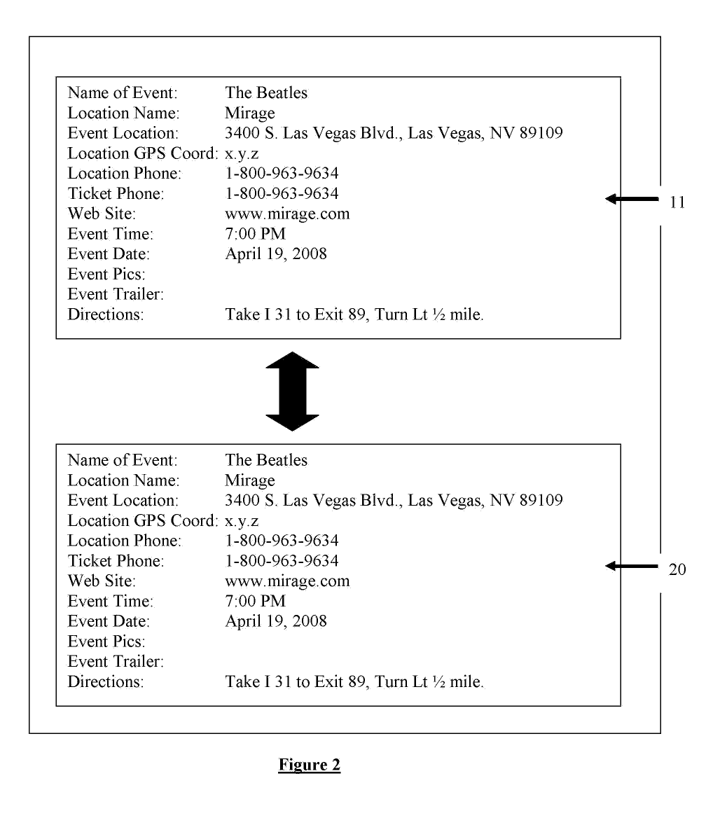

According to one aspect of the invention, as shown in FIG. 2, a mobile device ‘event information’ database (20) is provided for mobile devices such as mobile phones. The mobile device ‘event information’ database (20) comprises of data fields identical to data fields contained in web page ‘event information’ database (11). Means (21) is provided in mobile device to receive and integrate data from web page ‘event information’ database (11) into corresponding data fields of mobile device ‘event information’ database (20) contained therein. Preferably, two-way communication means between web page ‘event information’ database and mobile device ‘event information’ database is provided.

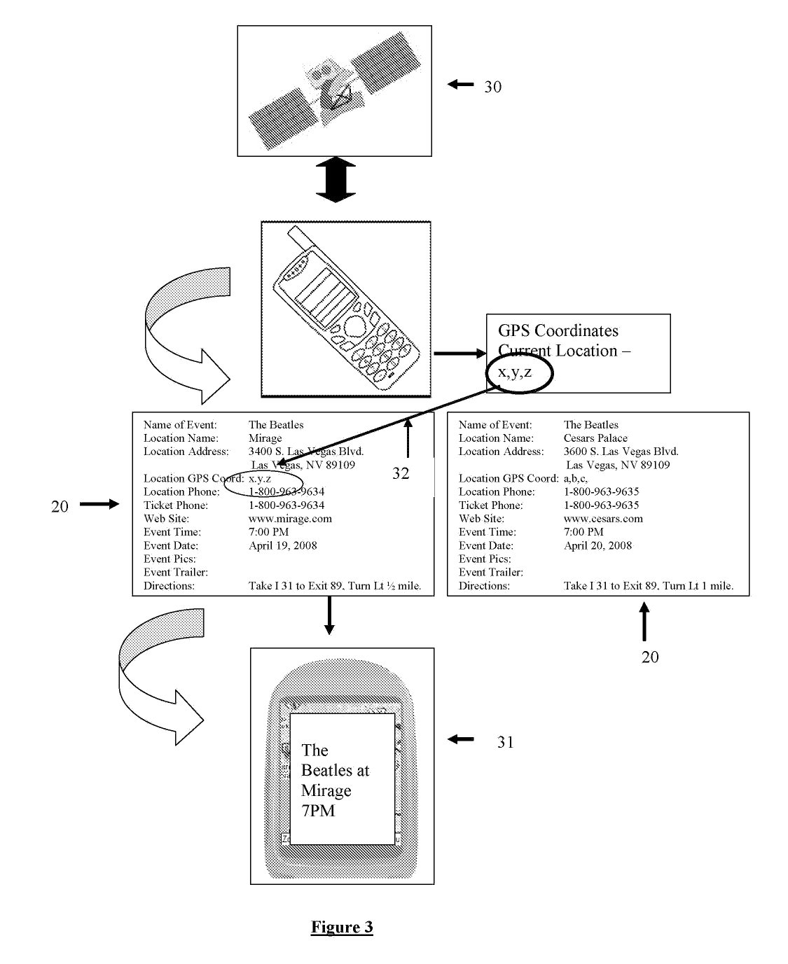

According to yet another aspect of the invention, as shown in FIG. 3, mobile device event reminder application is provided in GPS enabled mobile devices, such as mobile phones. Mobile device event reminder application has means to determine current location GPS coordinates using GPS satellites (30). Mobile device event reminder application can be programmed to determine satellite position at predetermined intervals, continuously, or upon user initiation. Additionally, means is provided in mobile device event reminder application to determine if GPS coordinates corresponding to current mobile device location matches with one or more GPS coordinates contained in mobile device ‘event information’ database (20,32), as shown in FIG. 3. Preferably, user is given option to set acceptable matching criteria for GPS coordinates of mobile device current location and GPS coordinates contained in mobile device ‘event reminder’ database. If a positive match corresponding to mobile device location is identified in mobile device ‘event information’ database, corresponding event information is displayed on mobile device (31). Additionally audio alarm means can be provided as additional reminder to user. In essence, location specific event published on web page is displayed to user on mobile device when user is physically present in proximity to event location. In practical terms, this enables users to surf the internet, search for location specific events such as local concerts, attractions, etc.; transmit and save location specific events; and event location GPS coordinates into mobile device. User is reminded of event information when physically present in proximity to event location. Means is provided in mobile device event reminder application to erase or deactivate event information that is past current date.

According to another aspect, means is provided for user to take further action based on displayed location specific information, such as buy tickets to a local show or auto dial displayed phone number. According to yet another aspect, means is provided for user to transmit data contained in mobile device ‘event information’ database from first to second mobile device. Preferably, means is also provided for user to upload data from mobile device ‘event information’ database onto internet; especially onto social networking sites such as www.myspace.com and www.facebook.com.

Although in the above discussion mobile device location is determined by GPS coordinates, other methods of mobile device location determination such as cellular tower triangulation, access point location etc. may be used. Data contained in web page and mobile device ‘event information’ databases can be one or more of text, voice, image and video. In addition to local events, the system and methods described in the invention can also be applied to any location specific information, such as local attractions.

I claim:

1. A location based event reminder system comprising of: 1) event information published on web; 2) determination of GPS coordinates corresponding to event location; 3) mobile device event information database containing data fields for event information and event location GPS coordinates; 4) means to transmit event information and event location GPS coordinates from web page to mobile device; 5) mobile device application having means to determine current location GPS coordinates; 6) mobile device application having means to determine matches in mobile device event information database corresponding to mobile device location GPS coordinates.

2. The location based event reminder system of claim 1; wherein event information corresponding to mobile device location is displayed on mobile device.

3. The location based event reminder system of claim 1; comprising of web page event information database containing data fields for user input of event information.

4. The location based event reminder system of claim 1; wherein event location GPS coordinates is determined from geo code database.

5. The location based event reminder system of claim 1; wherein event information is in one or more of text, audio, image, and video formats.

6. The location based event reminder system of claim 1; comprising of mobile device event information database containing data fields identical to web page event information database.

7. The location based event reminder system of claim 6 having means for two way data transmission between web page event information database and mobile device event information database.

8. The location based event reminder system of claim 1 having means for data transmission from event information database of first mobile device to event information database of second mobile device.

9. The location based event reminder system of claim 1 having means for data transmission from mobile device event information database to web.

10. A location based event reminder method comprising the steps of; 1) publishing event information and event location GPS coordinates on web page; 2) transmitting event information and event location GPS coordinates to mobile device; 3) mobile device determining mobile device location GPS coordinates; 4) mobile device determining event information corresponding to mobile device location.

11. The location based event reminder method of claim 10; wherein event information corresponding to mobile device location is displayed on mobile device.

12. The location based event reminder method of claim 10 wherein; event information is in one or more of text, audio, image, and video formats.

13. The location based event reminder method of claim 10 comprising event information databases for web page and mobile device; each database containing identical data fields for input of event information and event location GPS coordinates.

14. A location based event reminder system comprising of: 1) event information and event location published on web page; 2) mobile device event information database containing data fields for event information and event location; 3) means to transmit event information and event location from web page to mobile device; 4) mobile device application having means to determine mobile device location; 5) mobile device application having means to determine matches in mobile device event information database corresponding to mobile device location.

15. The location based event reminder method of claim 14 comprising event information databases for web page and mobile device; each database containing identical data fields for input of event information and event location.

16. The location based event reminder system of claim 14; wherein mobile device location is determined by access point location.

17. The location based event reminder system of claim 14; wherein mobile device location is determined by cellular tower triangulation.

18. The location based event reminder method of claim 14 wherein; event information is in one or more of text, audio, image, and video formats.

19. The location based event reminder system of claim 14 having means for data transmission from event information database of first mobile device to event information database of second mobile device.

20. The location based event reminder system of claim 14 having means for data transmission from mobile device event information database to web.
